(19) United States
(12) Patent Application Publication
(10) Pub. No.: US 2009/0266821 A1
(43) Pub. Date: Oct. 29, 2009

(54) MOLDED TANK WITH CAST-IN FITTING SEAT

(75) Inventors: DEAN JOHNSON, HOSPERS, IA (US); EUGENE VANDER GRIEND, HOSPERS, IA (US)

Correspondence Address: MCKEE, VOORHEES & SEASE, P.L.C., 801 GRAND AVENUE, SUITE 3200, DES MOINES, IA, 50309-2721, US

(73) Assignee: DEN HARTOG INDUSTRIES, HOSPERS, IA (US)

(21) Appl. No.: 12/108,293

(22) Filed: Apr. 23, 2008

(51) Int. Cl. B65D 85/00; B28B 1/20

(52) U.S. Cl. 220/565; 264/299; 264/310

(57) ABSTRACT

A plastic tank is rotationally molded with a cast-in steps seat for a leak-proof drainage fitting. The seat is formed during the molding process using a mandrel mounted on the mold wall. The seat provides substantially parallel surfaces to the outer wall surface of the tank so as to assure proper sealing of the fitting installed in the drain opening of the tank.

### FIELD OF THE INVENTION

The present invention is directed towards a molded plastic tank having an improved drain opening with a cast-in seat to provide a leak-proof seal with a drain fitting.

### BACKGROUND OF THE INVENTION

Plastic tanks of all sizes are used in various industries for storage and containment of liquids. Such tanks typically are manufactured using a rotational molding process with medium or high density polyethylene. Tanks often range in size from 20-10,000 gallons, although other size tanks may also be molded. A drain opening is normally provided near the bottom of the tank for drainage of liquid via a fitting mounted in the drain opening. A hose and/or valve may be connected to the fitting for drainage of liquid from the tank, as needed.

These conventional molded plastic tanks have walls normally thicker at the bottom of the tank to handle the increased stresses from the liquid. The inner and outer wall surfaces generally are not parallel, due to the limited control of wall thickness during the molding process. For example, the wall thickness may vary 10-20% over a relatively short distance of a few inches. When a conventional bulk head style or compression fitting is installed in the drain opening, the varying wall thickness and non-parallel nature of the inside and outside wall surfaces makes it difficult to provide a good seal, such that leakage is not uncommon. Ideally, there should be no more than 0.50 inch variation on the wall surfaces for proper sealing. The molded wall around the drain opening is normally outside this tolerance. Therefore, the inside wall surface must be manually ground or shaved so as to be substantially parallel with the outside wall surface. This grinding process is slow and tedious, requiring multiple measurements with calipers until a precise surface is provided, which may take 1.5 hours or more per drain opening. Thicker sealing gaskets are sometimes used to overcome defects and variations in the wall thickness, but are less than ideal, with leakage of liquid from the tank still a risk.

Accordingly, a primary objective of the present invention is the provision of an improved molded plastic tank having a cast-in fitting seat to provide a leak-proof seal for a drain fitting.

Another objective of the present invention is a method of manufacturing a plastic tank with a cast-in fitting seat.

Another objective of the present invention is the provision of a molded tank having a drain opening with parallel inner and outer wall surfaces surrounding the opening for installation of a leak-proof fitting.

A further objective of the present invention is the provision of a molding process for plastic tanks using a mandrel for forming a stepped seat around a drain opening in the tank wall.

Yet another objective of the present invention is the provision of a plastic tank molding process which minimizes the manufacturing time for the tank.

Still another objective of the present invention is the provision of an improved molded plastic tank which is economical to manufacture, and safe and durable in use.

These and other objectives will become apparent from the following description of the invention.

### BRIEF SUMMARY OF THE INVENTION

The molded plastic tank of the present invention has a cast-in seat formed during the molding process and extending around the drain opening for receiving a leak-proof fitting. The inner and outer walls surrounding the drain opening are substantially parallel. A stepped seat is formed on the inner surface of the wall around the drain opening during the molding process through the use of a mandrel. The mandrel has a non-stick surface for easy removal upon completion of the molding process. When the mold process is complete, the tank is ready for installation of a drain fitting without further processing or delay.

### BRIEF DESCRIPTION OF THE DRAWINGS

FIG. 1 is a perspective view of a molded plastic tank according to the present invention.

FIG. 2 is an enlarged view of a portion of the tank showing the drain fitting adjacent the bottom of the tank.

FIG. 3 is a sectional view showing a prior art tank with non-parallel inner and outer wall surfaces adjacent the drain opening.

FIG. 4 is an exploded view showing a portion of the tank wall adjacent the drain opening and the drain fitting according to the present invention.

FIG. 5 is a view of the mandrel used in the molding process, as mounting on a mold, according to the present invention.

FIG. 6 is a sectional view of a portion of the tank wall adjacent the drain opening during the molding process.

FIG. 7 is a sectional view showing the tank wall with the drain fitting installed in the drain opening.

FIG. 8 is an exploded perspective view of the mandrel, mold, and a portion of the tank wall around the drain opening.

### DETAILED DESCRIPTION OF THE PREFERRED EMBODIMENT

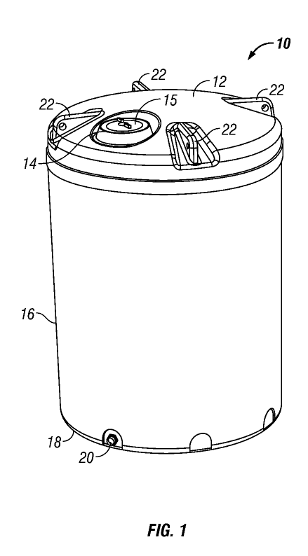

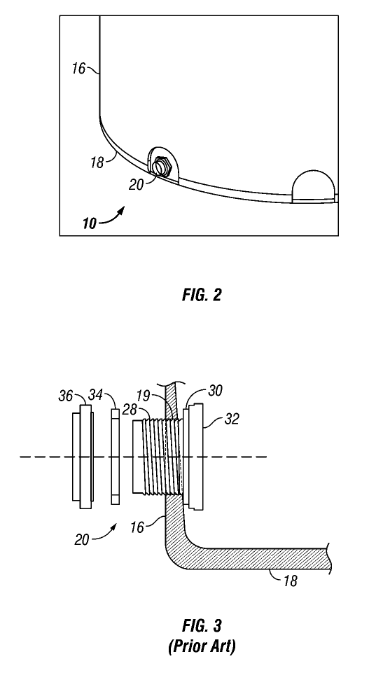

FIG. 1 shows one embodiment of a plastic tank 10 manufactured by a rotational molding process. The tank 10 is generally intended for storage and containment of liquids in various industries, such as for agricultural and industrial applications. The tank 10 includes a top 12 having a fill opening 14, a lid or cap 15 for the fill opening 14, a side wall 16, and a bottom 18. A drainage opening 19 with a drain fitting 20 is provided near the bottom 18 of the tank 10. Lifting lugs 22 are provided on the tank 10 for transport of the tank.

The tank 10 may take various sizes and shapes without departing from the scope of the present invention.

FIG. 3 shows a sectional view of a prior art tank 10 wherein the side wall 16 has non-parallel inner and outer surfaces 24, 26, respectively. Normally, the thickness of the side wall 16 increases near the bottom of the tank so as to accommodate the pressure of liquid contained in the tank 10. As seen in FIG. 3, the non-parallel surfaces 24, 26 of the side wall 16 creates difficulties in providing a leak-proof seal for the fitting 20. The fitting plug 28 is provided with a gasket 30 adjacent the plug head 32 on the inner surface 24 of the side wall, with a bearing washer 34 and fitting nut 36 on the outer surface 26 of the side wall 16. Tightening of the nut 36 compresses the gasket 30, but the gasket 30 may still allow leakage from the drain opening 19.

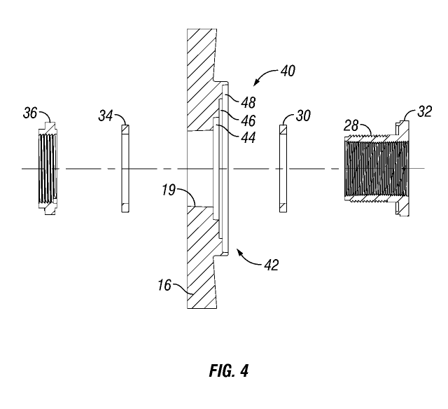

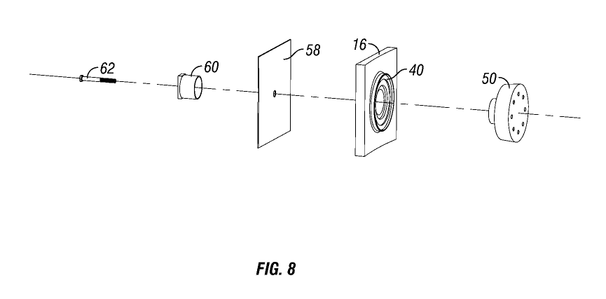

The improved tank 10 of the present invention includes a cast-in seat 40 surrounding the drain opening 19, as shown in FIGS. 4-8. The seat 40 includes a plurality of steps 42 which define step surfaces 44, 46, and 48 which are substantially parallel to the outer surface 26 of the side wall 16. When the fitting 20 is installed in the drain opening 19, the gasket 30 engages the inner step 40, and the plug head 32 engages the next step 46 of the seat 40, as shown in FIG. 7.

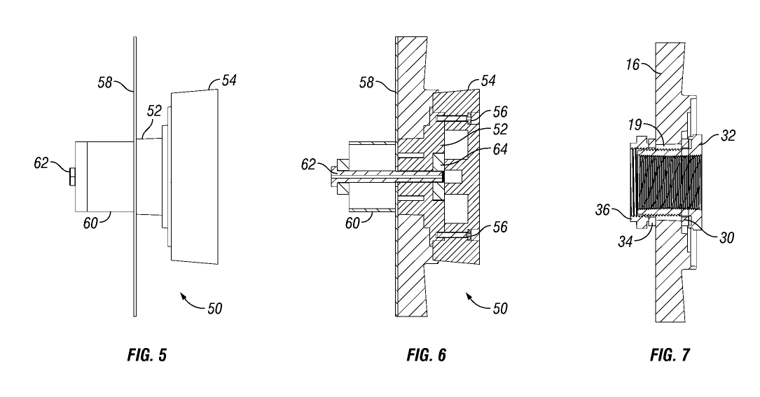

The seat 40 is formed during the rotational molding process using a mandrel 50. The mandrel 50 is shown in FIGS. 5, 6 and 8. The mandrel 50 includes a body 52 made of aluminum or other heat transferring material. A cap 54 is secured to the body 52 by screws or bolts 56. The cap 54 has a non-stick surface. The body 52 and cap 54 are mounted on the inside of a mold wall 58 via a securing fixture 60 and securing bolt 62 threadably connected to a nut 64 between the body 52 and the cap 54. Thus, the mandrel 50 automatically forms drain opening 19 and the seat 40 surrounding the drain opening 19 as the tank side wall 16 is formed during the rotational molding process. After the wall 16 has cooled, the nut 64 is removed so that the body 52 and securing fixture 60 can be disassembled from the mold wall 58. The mold wall 58 is then removed in a conventional manner from the formed tank 10. The drain fitting 20 can then be quickly and easily installed in the drain opening 19 without further processing of the tank wall 16.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives, and overcomes the problems in the prior art.

What is claimed is:

1. A molded plastic tank, comprising:
a molded wall having inner and outer surfaces which are non-parallel;
a drain opening molded in the wall;
a seat formed during molding of the tank and extending around the opening on the inner surface;
the seat being parallel to the outer surface of the wall; and
a fitting in the opening.

2. The tank of claim 1 wherein the seat is stepped radially outwardly from the drain opening.

3. The tank of claim 1 wherein the seat is formed by a mandrel secured in a mold for molding the tank.

4. The tank of claim 1 further comprising a drain fitting installed in drain opening.

5. The tank of claim 4 further comprising a seal between the seat and the fitting.

6. The tank of claim 4 further comprising a gasket between the seat and the fitting.

7. The tank of claim 4 wherein the fitting includes a threaded plug extending through the opening and a nut threadable on to the plug to retain the plug in the opening.

8. A method of forming a plastic tank, comprising:
molding the tank with a wall having non-parallel inner and outer surfaces;
molding a drain hole in the tank; and
molding a seat around the drain hole on the inner wall surface, the seat having at least one surface being parallel to the outer wall surface.

9. The method of claim 8 wherein the molding steps are performed simultaneously.

10. The method of claim 8 wherein the tank wall is formed by rotational molding using a mold.

11. The method of claim 8 wherein the drain hole and seat molding steps use a mandrel secured to the mold.

12. The method of claim 11 wherein the mandrel has a heat transferring body and a non-stick cap to form the drain opening and seat.

13. The method of claim 8 wherein the mandrel has a non-stick surface.

14. The method of claim 8 further comprising mounting a mandrel on a mold wall to automatically form the drain opening and seat while the wall is formed.

15. The method of claim 8 further comprising installing a drain fitting into the drain opening without further processing of the tank wall around the drain opening.

16. A plastic tank, comprising:
a wall with top and bottom ends;
a drain hole in the wall near the bottom end;
a seat extending around the drain hole on the inside of the wall;
a drain fitting in the drain hole to allow drainage of liquid from the tank at a selected time; and
the wall, drain hole and seat being formed simultaneously during a rotational molding process.

17. The tank of claim 16 wherein the seat includes stepped surfaces.

18. The tank of claim 17 wherein the stepped surfaces are substantially parallel to an outer surface of the wall around the drain hole.

19. The tank of claim 16 further comprising a sealing gasket between the fitting and the wall.

20. The tank of claim 19 wherein the gasket engages the seat.
